(19) United States
(12) Patent Application Publication
(10) Pub. No.: US 2011/0217150 A1
(43) Pub. Date: Sep. 8, 2011

(54) CONTAINER STORAGE YARD TRANSPORATION SYSTEM

(76) Inventors: Toru Takehara, Foster City, CA (US); Philip Alexander Tam, Oakland, CA (US); Tatsushi Takahara, Oita (JP)

(21) Appl. No.: 12/962,527

(22) Filed: Dec. 7, 2010

Related U.S. Application Data
(63) Continuation-in-part of application No. 12/831,207, filed on Jul. 6, 2010.
(60) Provisional application No. 61/267,355, filed on Dec. 7, 2009.
(60) Provisional application No. 61/392,393, filed on Oct. 12, 2010.
(60) Provisional application No. 61/267,347, filed on Dec. 7, 2009.
(60) Provisional application No. 61/299,969, filed on Jan. 30, 2010.

(51) Int. Cl. B65G 67/00; B65G 67/02

(52) U.S. Cl. 414/392; 414/809

(57) ABSTRACT

A container storage yard transportation system comprises a container storage yard having at least one container stacking area, at least one container handling cart delivery lane disposed alongside the container storage area, a container handling cart return lane associated with the delivery lane, a plurality of container handling carts disposed in the delivery and return lanes, gate handling equipment for transferring containers from ground transportation vehicles to handling carts in a loading position in the delivery lane such that the containers 1 an be transported to the container stacking area on the handling carts via the delivery lane, one or more yard gantry cranes for transferring the containers from the handling carts to the container stacking area, and cart shifting equipment for shifting empty handling carts between the delivery and return lanes such that the empty carts can be returned to the loading position via the return lane.

### CROSS-REFERENCE TO RELATED APPLICATIONS

This application claims the benefit of U.S. Provisional Application No. 61/267,355, filed Dec. 7, 2009, and U.S. Provisional Application No. 61/392,393, filed Oct. 12, 2010, and is a continuation-in-part application of prior application Ser. No. 12/831,207, filed Jul. 6, 2010, which claims the benefit of U.S. Provisional Application No. 61/267,347, filed Dec. 7, 2009, and U.S. Provisional Application No. 61/299,969, filed Jan. 30, 2010, all of which are hereby incorporated by reference.

### BACKGROUND

1. Field of the Invention

This invention is directed to a system for transporting cargo containers within container storage yards and between cargo container handling machinery, and in particular to such a system using cargo container handling carts.

2. Prior Art

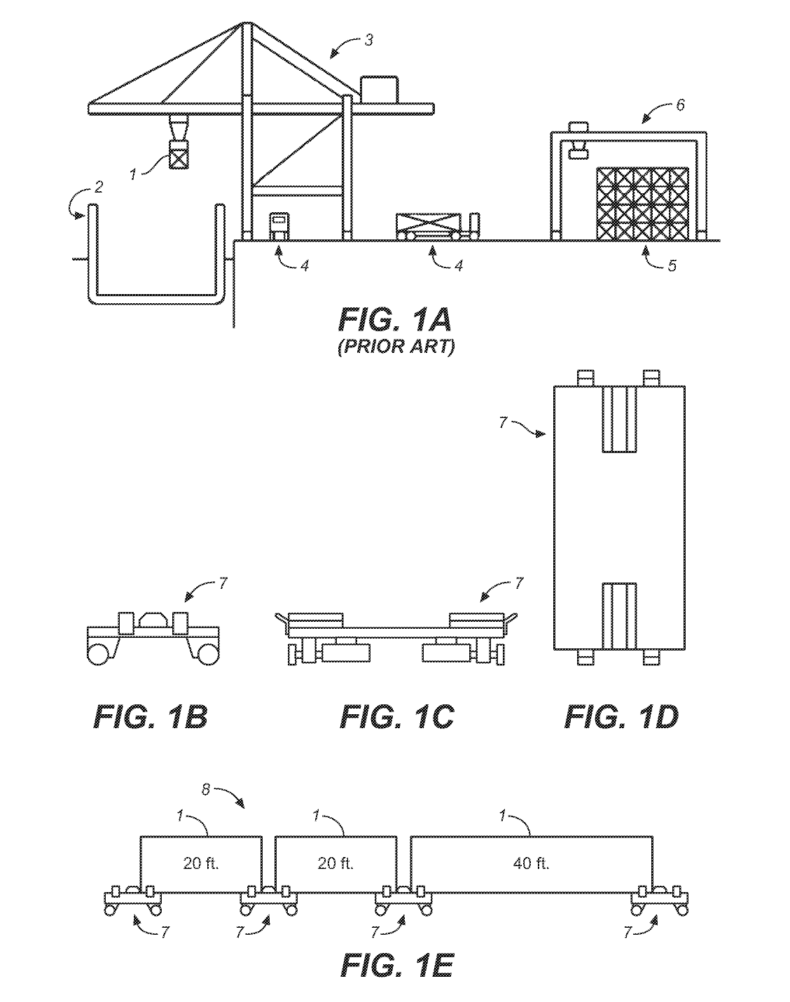

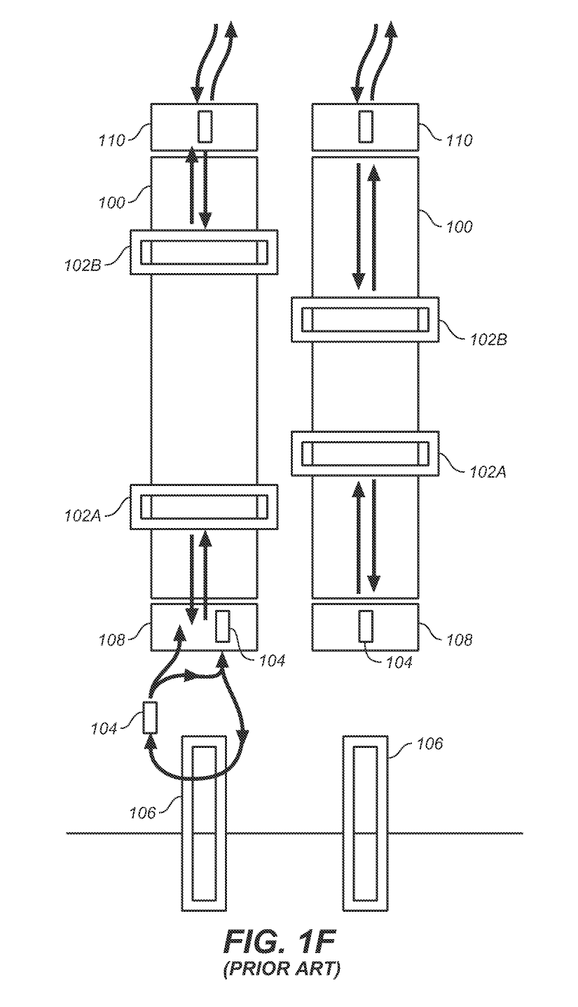

In conventional container terminal operations containers 1 are unloaded from container ships 2 using dockside cranes 3 onto any one of a variety of ground transportation vehicles including trucks with chassis 4, automated guided vehicles, rail cars and straddle carriers, for transport within the terminal, such as between the crane 3 and the container stacking areas 5 served by one or more yard cranes 6. See FIG. 1A. The shortcomings of this kind of operation are becoming increasingly apparent as container terminals push for more productivity and efficiency. Considering transportation by truck and chassis, for example, each truck requires a driver, and each chassis can carry at most one 40 ft, 45 ft, or 48 ft container (or one pair of 20 ft containers). Each chassis must be appropriately sized to accommodate the largest size container even though the largest container size is not the most commonly used container size. As a result, trucks with chassis have poor maneuverability and low efficiency. As container terminals become more productive, the truck transport operation is being pushed to its limit. It is inadequate to simply add more trucks and drivers, because doing so not only continues the inefficiency but contributes to vehicle congestion within the terminal.

In more modernized terminal facilities, substantial efficiencies are realized by using Automated Stacking Cranes (ASCs) to move containers. As shown in FIG. 1F, each container stacking area 100 is served by two ASCs 102. Containers 104 unloaded from a dockside ship by quay cranes 106 are moved then moved to a terminal vehicle interchange area 108 by terminal vehicles. The containers 104 are then picked up by a first one of the ASCs 102A and moved to a designated location in the container stacking area 100. In order to moved the containers from the container stacking area 100 to the outside truck interchange area, a “hand off” must take place between the first ASC 102A and a second ASC 102B. Thus, the second ASC 102B must pick the container 104 from its location in the container stacking area 100 and move it to the outside truck interchange area 110. A major disadvantage to the ASC container yard design is that a prototypical ASC can weigh two hundred tons or more. Therefore, when used as a container transport vehicle, ASCs consume a substantial amount of power and are expensive to operate. Moreover, since ASCs must shuttle back and forth between the container stacking area 100 and one or the other of the truck interchange areas, they must move at relatively high speeds in order to meet productivity demands. This further increases power demands, and increases wear and tear on the ASCs.

A significant improvement in efficiency over truck only container yards and ASC yard designs can be realized by using cargo container handling carts (hereinafter “handling carts, “container handling carts” or “carts”) such as described in detail in applicants' application Ser. No. 12/831,207. See FIGS. 1B-1D. A cargo container handling system using handling carts overcomes the inefficiencies and disadvantages inherent in prior art container storage yard transportation systems. A container storage yard transportation system according to the invention comprises a plurality of self-propelled handling carts each of which acts as a mobile platform capable of carrying one end of a container on each end of the cart. Thus, rather than requiring a single, large conventional carrier such as railcar or truck chassis to support and carry one container, substantially shorter carts according to the invention can be used to support one or more containers by supporting only the ends of the containers rather than the entire length of each container. At least two carts 7 are used to support a single container 1, one to support the rear end of the container, and another cart to support the front end, as shown in FIG. 1E.

The cargo container handling system allows formation of a series of containers, generally referred to as a “container train.” See FIG. 1E. Each cart can support the front of one container 1, and the back of another, thus linking adjacent pairs of containers and effectively creating a container train 8. There is no limit to the train length as long as individual carts 7 are available. The physical length of a container train formed using handling carts is shorter than a conventional train for carrying containers because the length of a container train is determined by the combined lengths of the containers in the train rather than the combined lengths of the rail cars used to form a conventional train. The reduced weight of each cart causes less wear and tear on the terminal facility than a conventional train, and reduces wear on other terminal equipment, such as ASCs, which would otherwise be used to carry containers within the terminal, and permits more efficient use of card stacking equipment which need not be so dedicated to moving containers along a container stacking area. The smaller size and weight of the container handling cart also makes it more maneuverable, more flexible, and easier to handle than rail cars, truck chassis and ASCs. Moreover, empty carts can move freely, occupy smaller spaces due to their smaller footprints, and can easily be shifted from one location to another by any cart handling machine.

While container handling carts will improve the storage yard operation by providing more flexible, efficient transport vehicles for containers, full implementation of the system requires supplemental handling equipment and a new yard design in order to operate efficiently.

### BRIEF DESCRIPTION OF THE ILLUSTRATIONS

FIG. 1A is an elevational representation of a conventional container storage yard transportation system using trucks and chassis.

FIGS. 1B-1D are side, end and plan views, respectively, of a container handling cart.

FIG. 1E is an elevational view of a container train formed using container handling carts of the type shown in FIGS. 1B-1D.

FIG. 1F is a schematic diagram showing a yard cart layout using Automated Stacking Cranes.

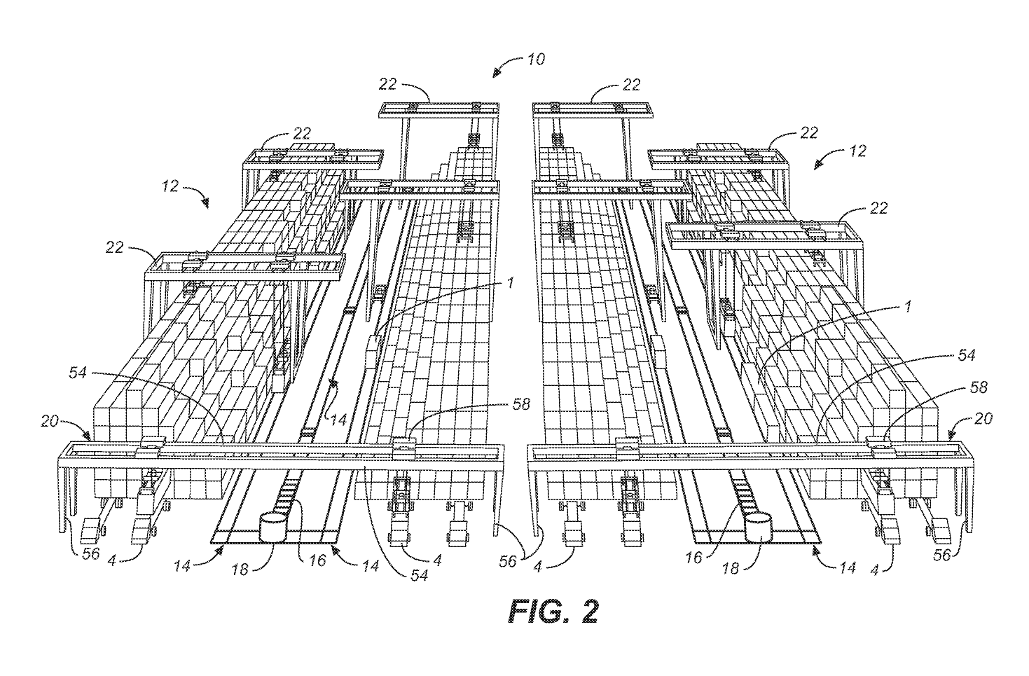

FIG. 2 is an upper perspective view of a container storage yard transportation system according to the invention.

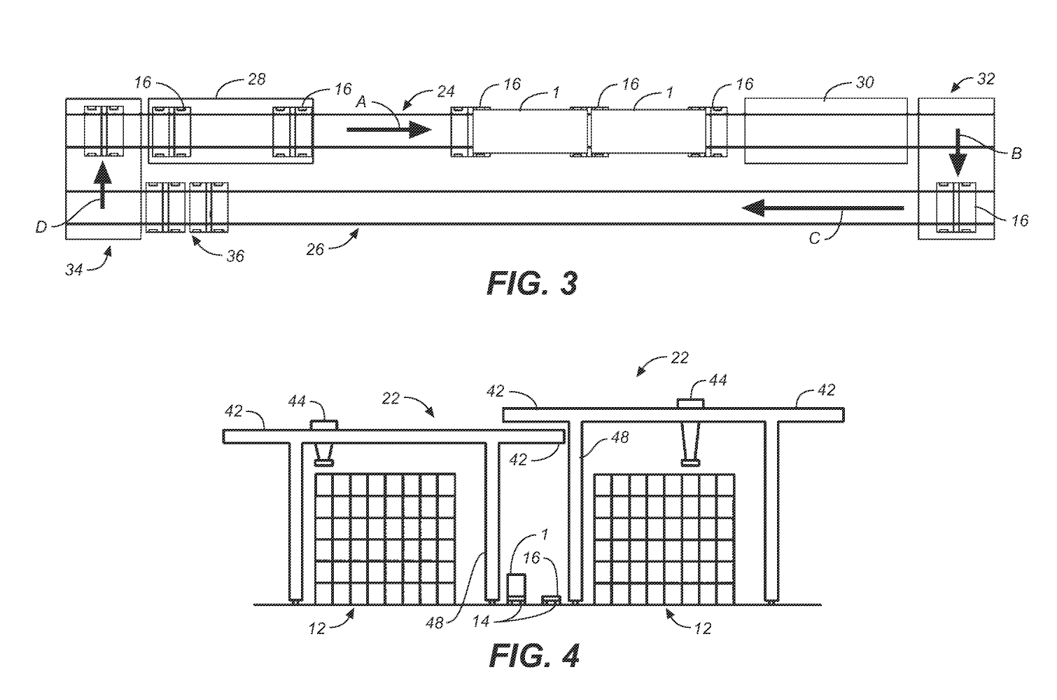

FIG. 3 is a plan view of a cart lane configuration for loading and unloading containers using handling carts.

FIG. 4 is an elevational view showing cart lanes located between two yard gantry cranes.

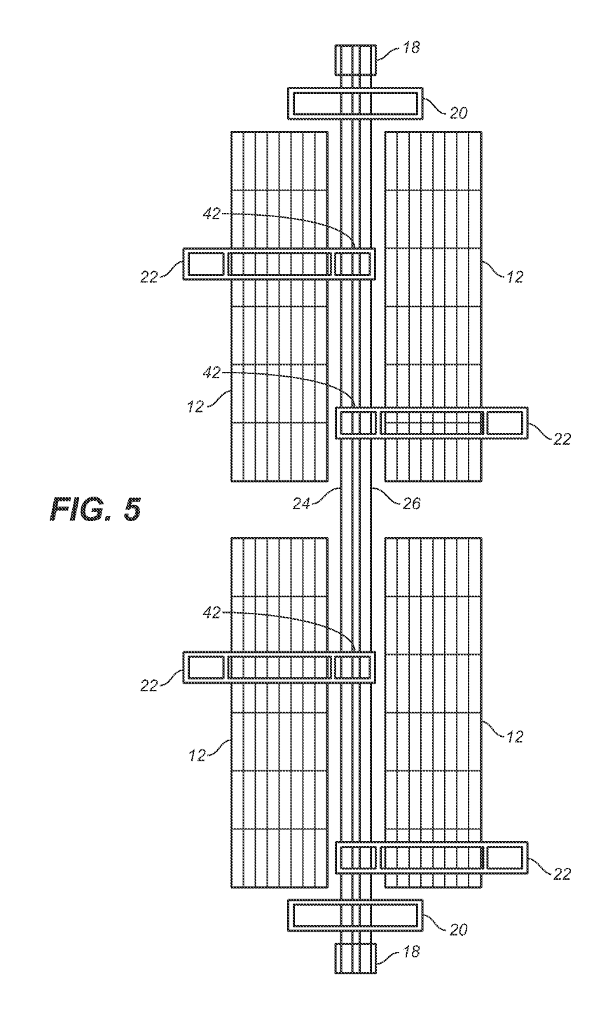

FIG. 5 is a schematic representation of the layout of a container storage yard showing multiple container stacking areas, cart lanes, yard cranes, and cart shifting devices.

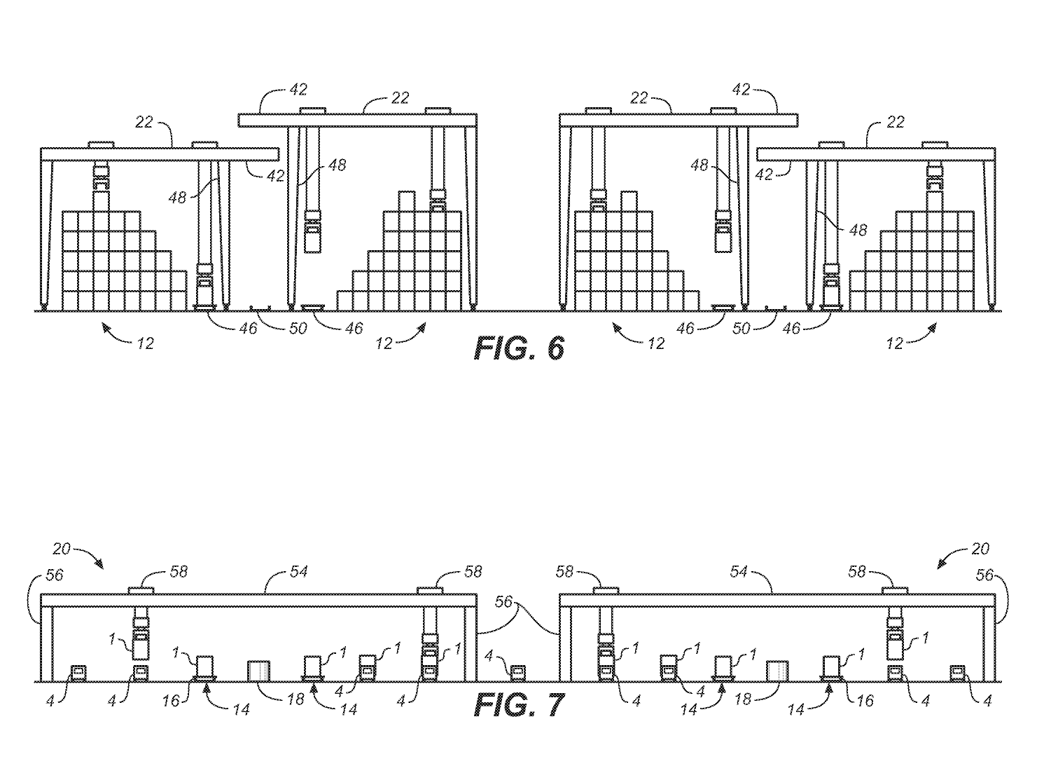

FIG. 6 is an elevational view of adjacent, opposing yard gantry cranes having overlapping, single cantilevered sections with staggered heights.

FIG. 7 is an elevational view of gate handling equipment at one end of a container storage yard.

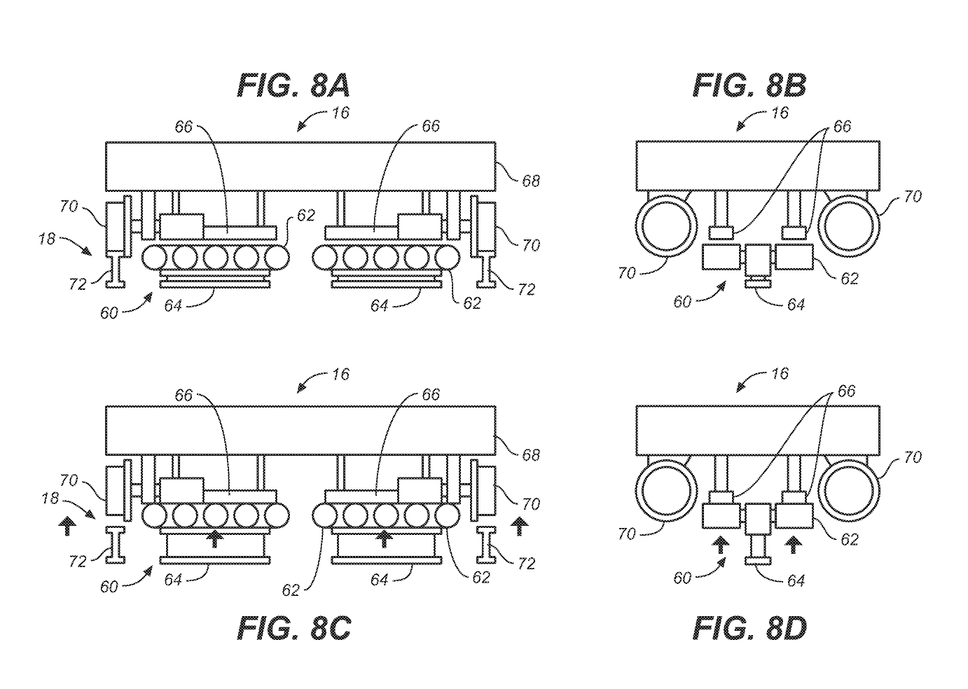

FIGS. 8A and 8B are end and side views, respectively, of a cart shifting device showing a cart having jacking pads positioned over jacked conveyors disposed in a rest position.

FIGS. 8C and 8D are end and side views, respectively, of the cart shifting device shown in FIGS. 8A and 8B showing the jacked conveyors in an elevated position and the wheels of the cart elevated above lane rails.

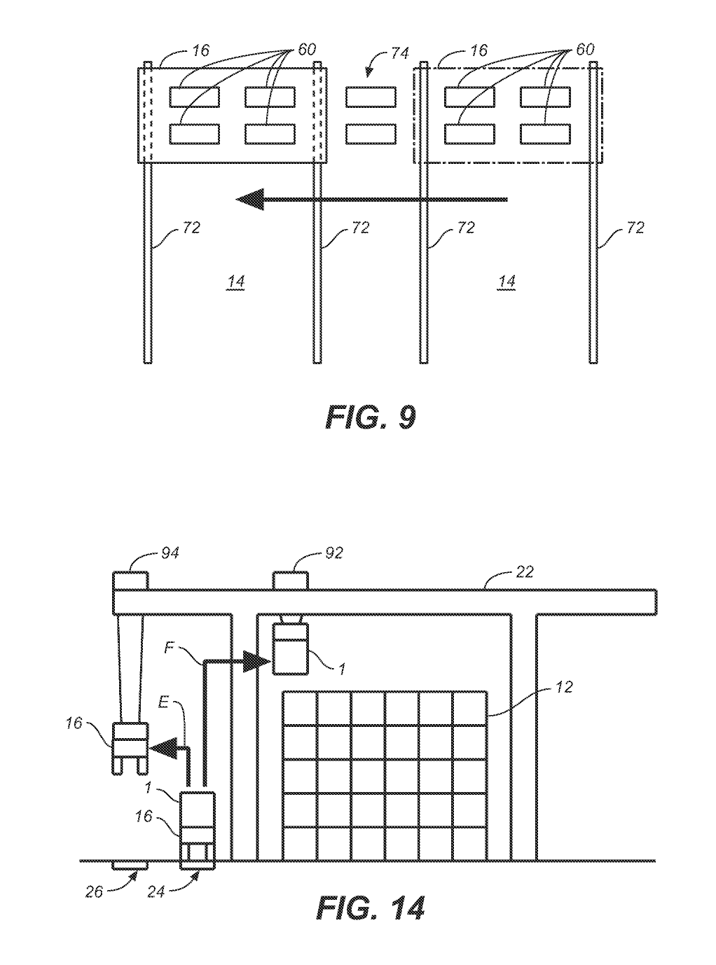

FIG. 9 is a schematic overhead representation of jacked conveyors such as that shown in FIGS. 8A-8D in adjoining cart lanes and a bridge conveyor intermediate the cart lanes.

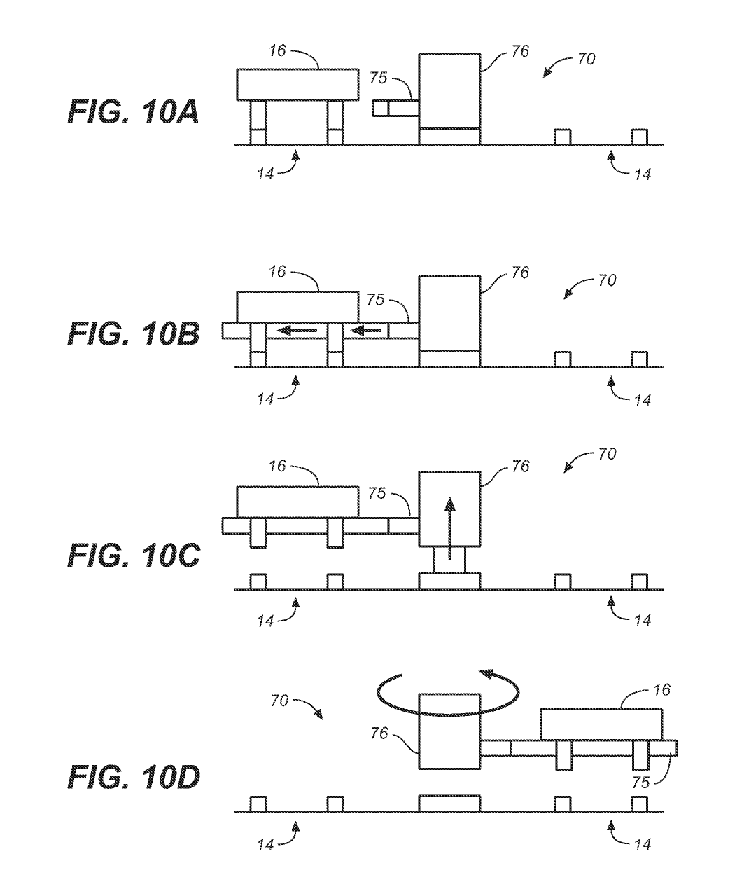

FIGS. 10A-10D are elevational views showing the operation of a telescoping forklift used as a cart shifting device for transferring carts between cart lanes.

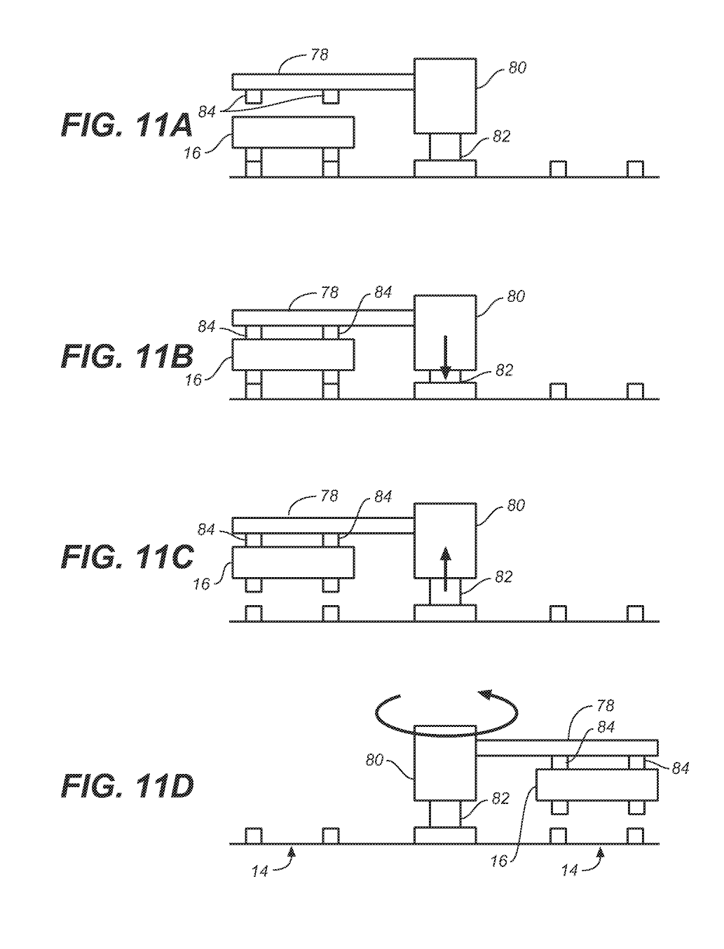

FIGS. 11A-11D are elevational views showing the operation of a vertical lifting device used as a cart shifting device for transferring carts between cart lanes.

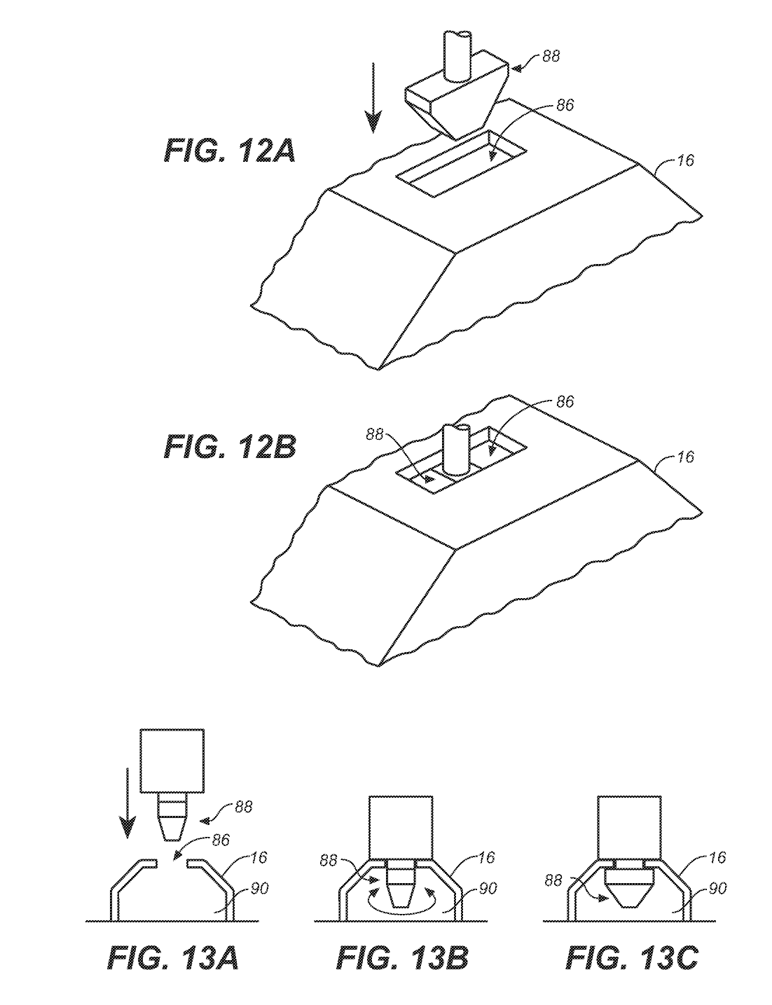

FIGS. 12A and 12B are upper perspective views showing engagement of a twistlock with a twistlock cavity in a handling cart.

FIGS. 13A-13C are side elevational views showing the stages of engagement of a twistlock with a twistlock cavity in a handling cart.

FIG. 14 is an elevational view of a yard gantry crane having two hoist trolleys and one of two cantilevered sections extending over the cart lanes.

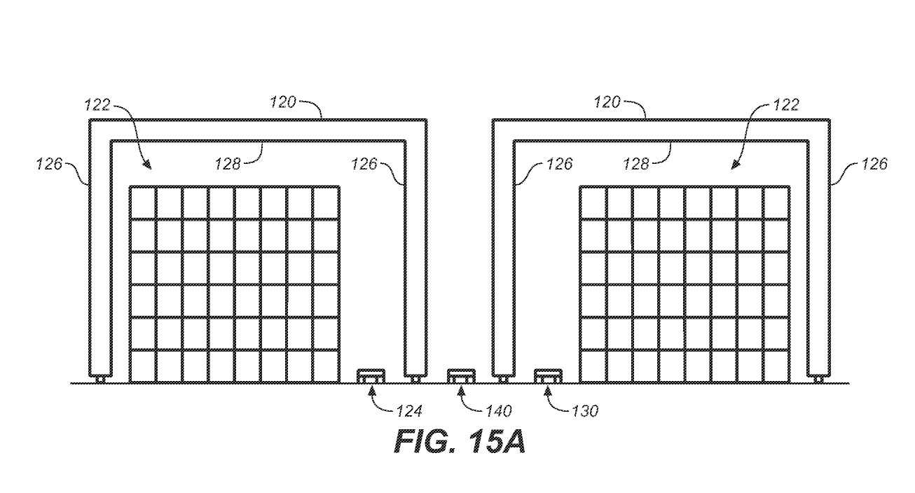

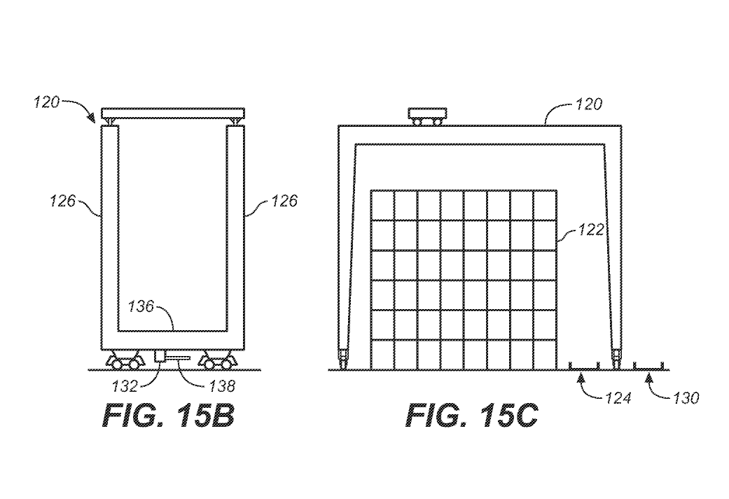

FIG. 15A is an elevation view showing two container stacking areas each served by a portal crane.

FIG. 15B is a side view of a portal crane such as shown in FIG. 15A showing a cart shifting device suspended from the portal beam of the portal crane.

FIG. 15C is a front elevational view of the portal crane of FIG. 15B in position over a container stacking area, and showing two container handling cart lanes adjacent the container stacking area.

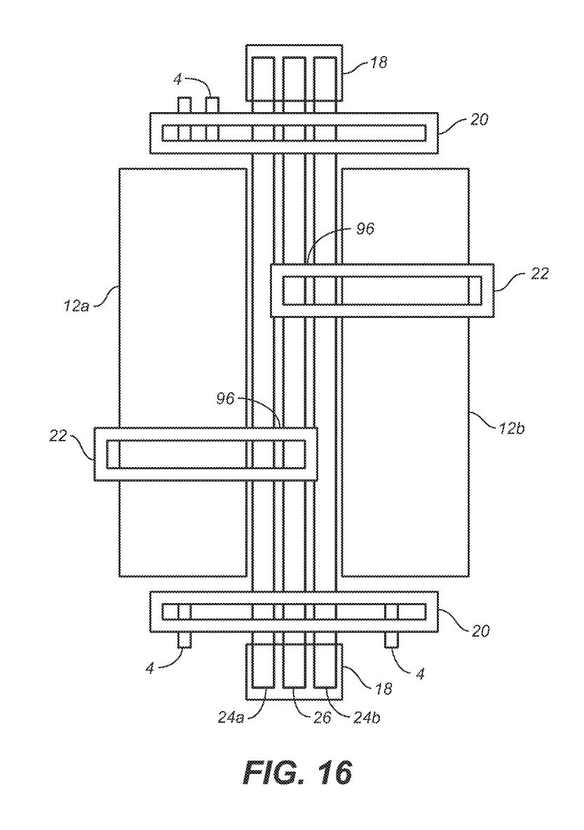

FIG. 16 is a schematic representation of the layout of a container storage yard transportation system having two container stacking areas, three cart lanes including two delivery lanes and one return lane, cart shifting devices at each end of the cart lanes, gate handling equipment, and a yard gantry crane for each container stacking area.

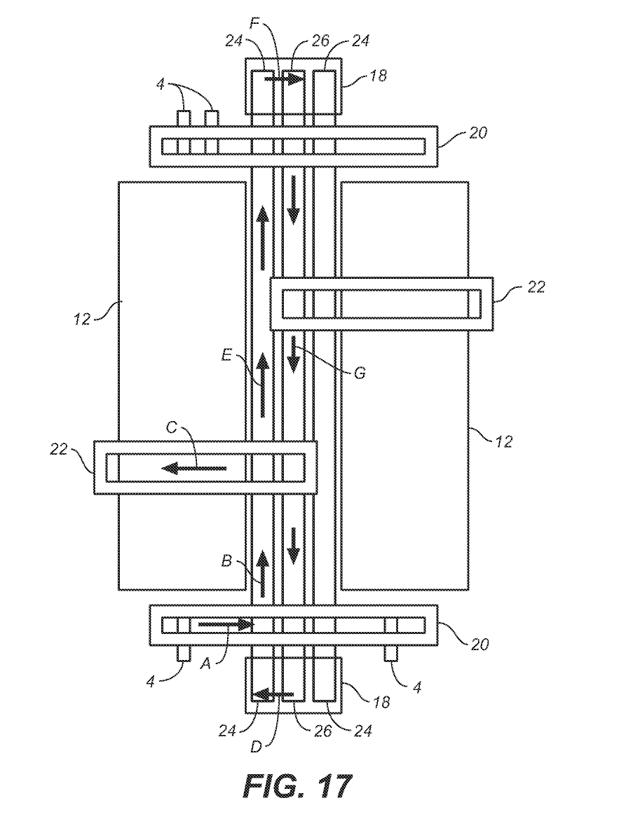

FIG. 17 is a diagram showing the paths of movement of handling carts and cargo containers according to container storage yard transportation system.

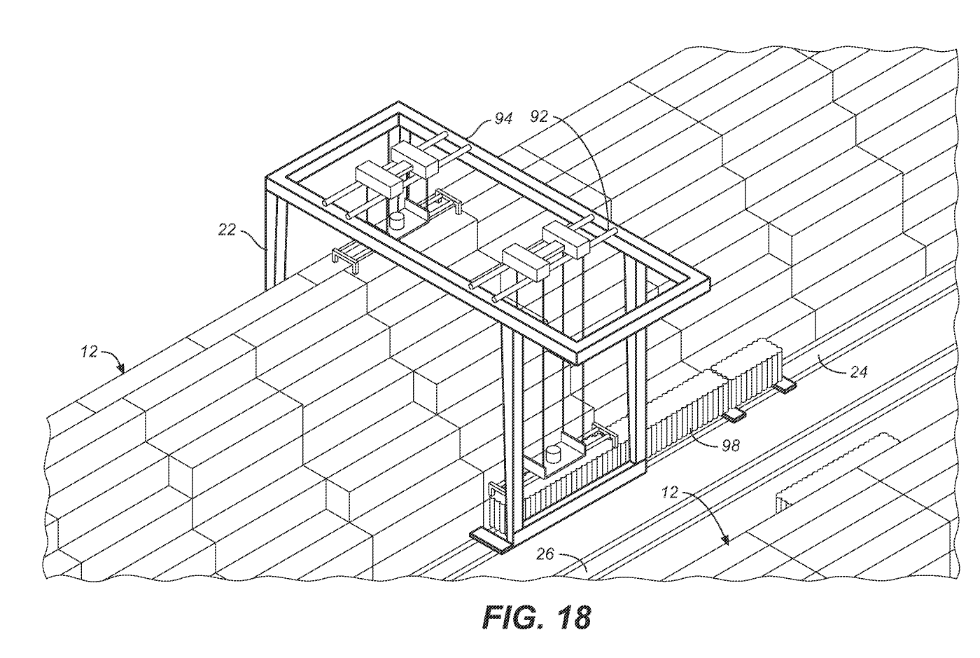

FIG. 18 is an upper perspective view of a yard gantry crane having two hoist trolleys and a single cantilevered section extending over one of the delivery lanes and the return lane of the cart lanes.

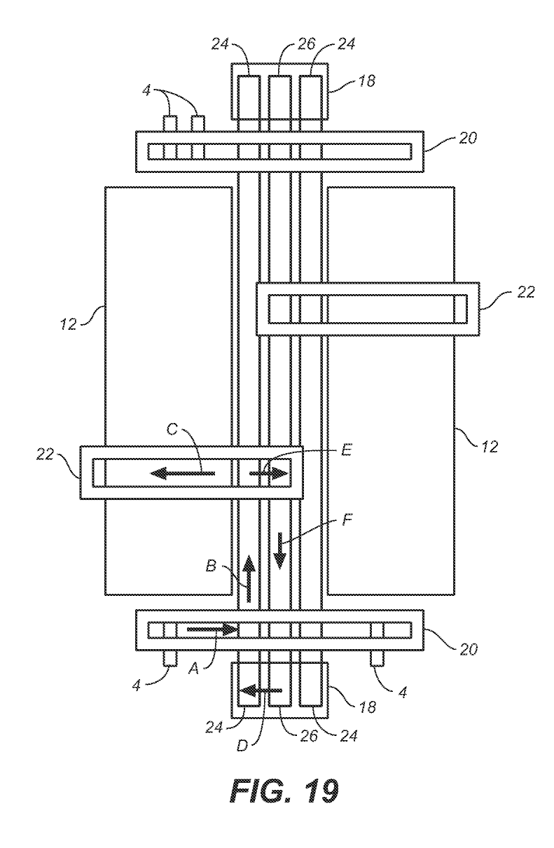

FIG. 19 is a diagram similar to that shown in FIG. 16 showing an alternate path of movement of handling carts and cargo containers according to applicants=container storage yard transportation system.

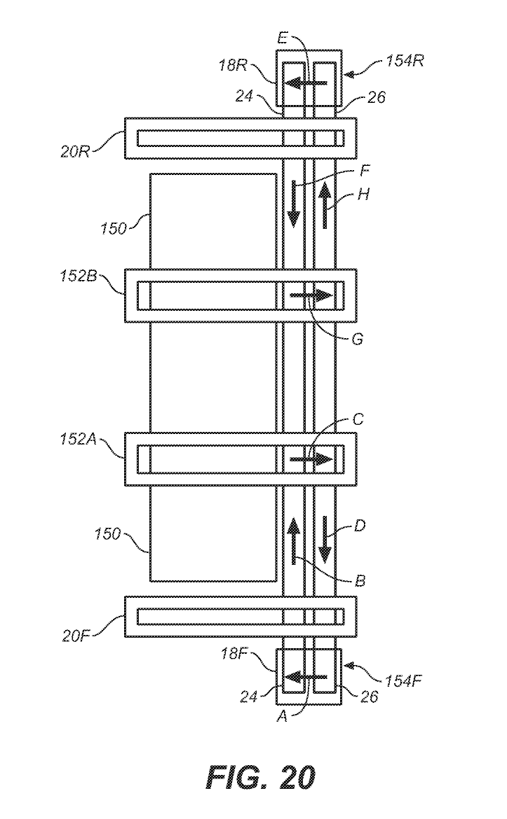

FIG. 20 is a plan view of a representation of a cart yard layout including a container stacking area served by two gantry cranes and two container handling cart lanes adjacent the container stacking area.

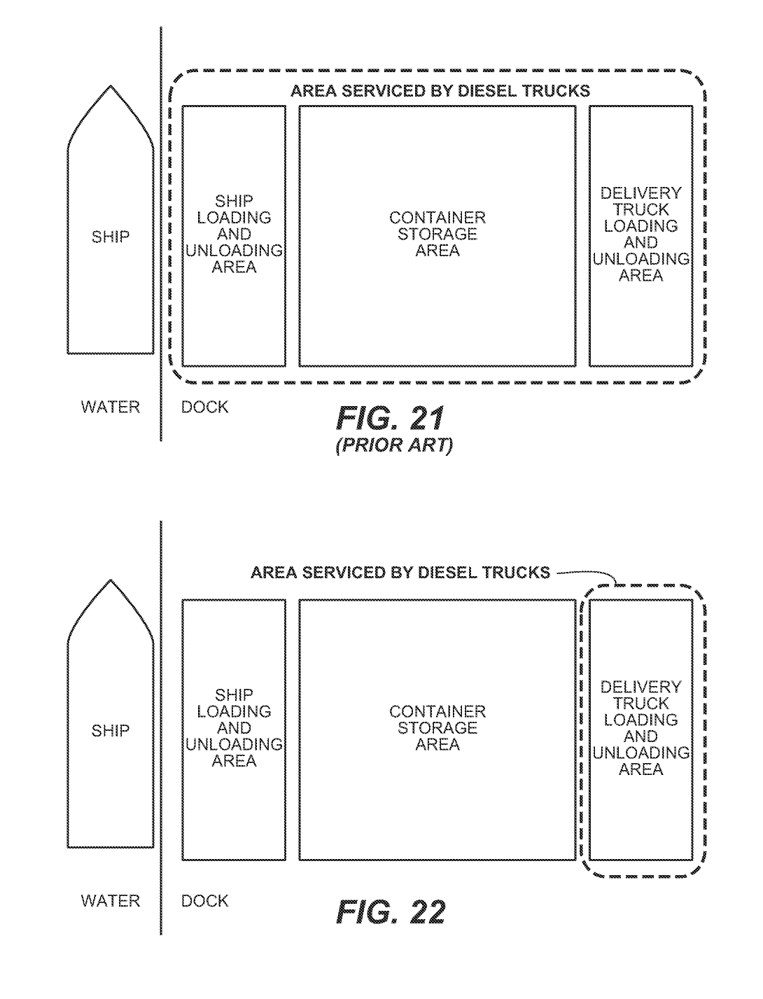

FIG. 21 is a schematic representation of a prior art container storage yard.

FIG. 22 is a schematic representation of a container storage yard in which applicants' container storage yard transportation system is operational.

### DETAILED DESCRIPTION OF THE ILLUSTRATED EMBODIMENTS

A container storage yard transportation system 10 using handling carts to transport containers within a storage yard is depicted in FIG. 2. Adjacent container stacking areas 12 are served by cart lanes 14. A plurality of handling carts 16 move in the cart lanes 14 alongside container stacking areas 12. Cart shifting devices 18 move carts 16 between cart lanes 14 permitting each lane to be dedicated to a single direction of travel as discussed in greater detail below.

Gate handling equipment 20 serves as the transfer mechanism for moving containers between carts and external ground transportation vehicles, such as trucks 4, while carts 16 transport containers 1 within the storage yard between other container handling equipment such as the gate handling equipment 20 and yard gantry cranes 22.

While an effective embodiment of a layout of a container storage yard transportation system is shown in the illustrations, there are other variations of layouts, equipment, and equipment design that can employ container handling carts to transport containers within a container storage yard. The following sections will describe details of the operation, and various designs of the equipment mentioned above.

Cart Circulation Using Multiple Linear Lanes

One method of employing container handling carts is to use them in a linear circulating transport scheme as shown in FIG. 3. In the illustrated configuration, two cart lanes are used, a delivery lane 24 for delivering containers to container stacking areas, and a return lane 26 for returning empty carts 16 to a home location. Any number of lanes may be used to provide additional transport capacity according to need. When there are more than two lanes, some lanes may be allocated to delivering containers, while others can be designated as return lanes to bring carts back to the loading area. This allows the carts to circulate between various positions in the yard. The lane assignments can be altered during operation to suit the operational requirements, or can be preset by design. This will provide rapid movement of the containers in one direction, acting as a rapid conduit between lane locations, such as sites where container handling machines are positioned.

In the configuration shown in FIG. 3, two or more carts 16 are positioned at a loading position 28 where a container 1 can be loaded on cooperating pairs of carts 16 by gate handling equipment (see again FIG. 2). A container train can be formed at the loading position by loading two or more containers on carts 16. Once loaded, the containers 1 are transported, as indicated by arrow A, along delivery lane 24 to an unloading position 30 where the containers 1 are picked off of the carts 16 and moved to an adjoining container stacking area 12 (FIG. 2). Once the carts have been unloaded, they may be moved to a remote cart shifting area 32 where they are shifted, as indicated by arrow B, from the delivery lane 24 to the return lane 26 by one of several kinds of cart shifting mechanisms discussed below. Having been shifted to the return lane 26, carts 16 are returned, as indicated by arrow C, to a home cart shifting area 34 where they are shifted, as indicated by arrow D, from the return lane 26 to the delivery lane 24 whence they can be moved again to the loading position 28 as needed. It should be noted that empty carts 16 can be together into a collapsed configuration, as seen at 36 in FIG. 3, for moving multiple carts from point to point, thereby significantly reducing congestion in the cart lanes and the storage yard in general.

In the illustrated embodiment cart shifting devices are indicated to be present at each end of the cart lanes 16. However, cart shifting devices may also be dispersed at selected locations along the lanes in order to provide intermediate transfer positions between lanes without having to shuttle carts all the way to the lane ends. Furthermore, although a loading position is designated in the illustrated embodiment for efficient operation by utilizing the gate handling equipment 20, containers 1 may be loaded onto carts 16 at any position along the lanes 14 by other machinery such as yard gantry cranes 22. Any machinery that can move containers 1 can be used to load or unload the carts such as rubber tire gantry cranes, cantilevered cranes, top-handlers, and jib cranes. Similarly, although an unloading position is shown in the illustrated embodiment, containers may be removed from carts 16 anywhere along the lane that is accessible to equipment capable of moving containers. It should be noted that terms throughout this application and in the illustrations are designations made for description purposes only. For example, the terms delivery lane and return lane are not to be construed as limiting lane use exclusively for delivering containers or returning carts, but are for illustration purposes only. Both lanes are capable of carrying loaded carts and empty carts simultaneously, and are capable of handling cart movement in either direction upon reassignment.

Cargo Handling Equipment Access to Loading/Unloading Positions

The loading and unloading positions described in the preceding section indicate locations where container handling equipment, such as yard gantry cranes, can deposit or retrieve containers to and from carts. Some conventional equipment can deposit or retrieve containers without any design modification, but other equipment may need to be specially designed or modified to facilitate use of multiple cart lanes.

FIGS. 4 and 5 illustrate one such operating system within the storage yard of a container terminal. Yard gantry cranes 22 load and unload handling carts 16 in cart lanes 14 and stack containers 1 in the container stacking areas 12. With additional reference to FIG. 2, gate handling equipment 20 moves containers between ground transportation vehicles and carts 16 in cart lanes 14 thereby providing an access point for containers entering and leaving the storage area. The handling carts 16 thus act as rapid container transport devices, efficiently moving containers between different locations in the storage yard, while cart shifting devices 18 transfer carts 16 between lanes 14 facilitating the linear circulating transport scheme discussed above.

Yard gantry cranes 22 are each provided with a cantilevered section 42 extending over the cart lanes 14 as shown in FIG. 4 permitting access by at least one of the hoist trolleys 44 on the crane 22 to containers 1 in the lanes 14. By providing opposing cranes with cantilevered sections, both cranes may efficiently access the same lanes. Those of skill in the art will understand that the cantilever 42 may be on one (see FIG. 6), or both sides of the crane (FIGS. 4 and 5). It is noted that some cart lanes 46 may be positioned between the container stacking area 12 and the crane legs 48, as shown in FIG. 6, but in such an arrangement the lane 46 is only accessible by one crane. By staggering crane heights, the cantilevered section 42 of one crane 22 passes over the cantilevered section of another during gantry movement. See FIGS. 4 and 6.

There are many crane designs and layouts available that can be used to load and unload containers to carts along the cart lanes. If one lane is not under a cantilevered section of a yard crane, but is instead located between the legs of the crane and adjacent to the container stack, the lane is accessible by only one crane. See FIGS. 2 and 6. But this apparent disadvantage allows the length of the cantilever to be reduced which simplifies the crane structure. Thus, depending on lane placement and crane design, some of the cart lanes may be under a cantilever, while others are placed between crane legs, making some of the lanes accessible by cranes on both sides, whereas others are accessible by only one crane.

FIG. 6 shows a layout employing single cantilever yard gantry cranes. Each crane 22 has a dedicated delivery lane 46, and a shared return lane 50 is positioned beneath the cantilevered sections 42 of the cranes 22. Each lane 46, 50 runs in a single direction, the return lane 50 running in the opposite direction than that of the delivery lanes 46, thereby relieving cart traffic in the delivery lanes by circulating carts back and away from congested areas in the delivery lanes 46.

Gate Handling Equipment

Dedicated gate handling equipment 20 is used to transfer containers between the carts 16 in lanes 14 and external ground transportation vehicles such as trucks 4 (see FIG. 2) or automated guided vehicles. Although gate handling equipment can be located anywhere with access to the cart lanes 14, it is ideally located at the ends of the lanes at home and remote cart shifting areas 18, as shown in FIG. 5. This arrangement allows external vehicles to remain at the perimeter of the yard, effectively separating the storage yard operation from external operations.

Referring now to FIGS. 2 and 7, gate handling equipment 20 according to one embodiment comprises a bridge 54 supported on fixed columns 56. The bridge 54 supports hoist trolleys 58 which range over the cart lanes 14 and ground transportation equipment 4 parked underneath the bridge 54. This allows external vehicles to deliver containers to or retrieve containers from the storage yard since the gate handling equipment 20 can transfer containers 1 between the external vehicles 4 and carts 16 located in lanes 14.

Cart Shifting Device

A cart shifting device 18 is indicated generally in FIGS. 2 and 7. A cart shifting device 18 shifts or transfers carts 16 from one cart lane 14 to another. There are several methods of accomplishing this based on the cost of the system and the desired layout and performance of the mechanism. One embodiment of a cart shifting device 18, shown in FIGS. 8A-8D, comprises jacked conveyors 60. A jacked conveyor 60 includes one or more conveyors 62 supported by a jack 64. By lifting the jack 64, the jacked conveyor 60 can be elevated from a rest position, as shown in FIGS. 8A and 8B, to an elevated position, as shown in FIGS. 8C and 8D. Each cart 16 is provided with one or more jacking pads 66 depending from the frame 68 of the cart 16. When the jacked conveyor 60 is in the rest position, the jacking pad 66 is spaced above the conveyor 62 allowing the cart 16 to roll over it. Elevating the jacked conveyor 60 lifts the wheels 70 of the cart 16 off the cart lane rails 72 as shown in FIGS. 8C and 8D. The cart 16 can then be rolled sideways on the conveyor 62 from one lane to the other. As shown in FIGS. 8B and 8D, the conveyors are sufficiently centered that wheels 70 encounter no interference from the conveyors 62 during lateral movement of the cart. If spacing between lanes 14 requires it, bridge conveyors 74 are used to span the intervening distance to move carts 16 from one lane 14 to the other as indicated by the arrow in FIG. 9.

Another embodiment of a cart shifting device 18 comprises telescopic forklifts 70 mounted on a rotating structure 73 as shown FIGS. 10A-10D. Forklifts 70 comprise forks 75 mounted in a housing 76 which extend from a retracted position, shown in FIG. 10A, to an extended position, shown in FIG. 10B, underneath a cart 16. Forks 75 may be provided on one side or two sides of the housing 76. The forks 75 may telescope using different types of actuators including: (a) electro-mechanical motors, (b) linear motors, or (c) hydraulic/pneumatic pistons. Once the forks 75 are positioned under the cart 16, the housing 76 is elevated causing the forks 75 to lift the cart 16 as shown in FIG. 10C. Elevation may be achieved by using hydraulic cylinders, although electro-mechanical options may be used to reduce environmental concerns from hydraulics. Once elevated, the housing 76 is rotated, and the cart is translated to a different lane 14, as shown in FIG. 10D, and lowered.

Yet another embodiment of a cart shifting device 18 uses a vertical lift system to lift the carts from above as shown in FIGS. 11A to 11D. Similar to the preceding embodiment, a lifting arm 78 extends from a housing 80 which is mounted on a rotating structure 82. A hydraulic piston is used to lift arm 78 to a position above cart 16, whereupon arm 78 is rotated over the cart 16 as shown in FIG. 11A. The arm 78 is then lowered onto the cart 16 where locking devices 84 are used to lock onto the top of the cart 16 as seen in FIG. 11B. The cart 16 is then lifted by elevating the housing 80, as shown in FIG. 11C, and rotated to place the cart 16 over a different lane 14, as shown in FIG. 11D, and then lowered. In one embodiment, the locking devices 84 comprise rectangular openings 86 built into the top of the cart structure and twist-locks 88 depending from lifting arm 78 which fit through the rectangular openings 86 and turn to lock into place as shown in FIGS. 12 and 13A to 13C. One advantage of the vertical lift system embodiment is that it is mechanically simple and utilizes existing twistlock and corner casting technologies.

A mechanism for lifting the cart via a standard twistlock is illustrated in FIGS. 13A-13C. The top of the cart 16 may optionally be hollow or can be provided with one or more cavities or recesses 90 accessible through top opening 86. As best seen in FIG. 12, the top opening 86 is rectangularly shaped and sized to receive the twistlock 88. The cavity 90 is large enough to permit the twistlock 88 to rotate once it is fully received in the cavity 90 as shown in FIG. 13B, such that the twistlock 88 is secured in the cavity as shown in FIG. 13C. In this manner, a lift arm 78 having twist locks 88 can be used to lift a cart 16 to shift it between cart lanes 14.

Yard Gantry Crane Lane Transfer

In the container storage yard transportation system and method described above, cart shifting devices 18 and gate handling equipment 20 are used to transfer carts 16 from one lane 14 to another. However, these machines are usually located in fixed positions. For additional transferring functionality, the yard gantry crane 22 can also be used to lift a cart 16 and transfer it between lanes 14. The spreader mechanism on most yard gantry cranes used to lift containers 1 can also be used to lift carts. But the yard gantry crane 22 must have access to multiple lanes for this to occur. While a yard gantry crane 22 with a single trolley can be used to transfer carts 16 between lanes 14, the yard crane 22 will not be as productive since the trolley hoist will be required to handle both containers 16 and carts C.

One method of creating a more productive process is to install two trolley hoists on a yard gantry crane 22 as shown in FIG. 14. While a first trolley hoist 92 may focus on moving containers between the carts 16 and the container stack 12, a second trolley hoist 94 can be used to transferring carts 16 between lanes 14. In one embodiment in which the second trolley hoist 94 is designed for and dedicated entirely to moving carts 16, the second trolley hoist 94 may be a simpler and lighter version of a conventional trolley hoist. In another embodiment second trolley hoist 94 may be a regular trolley hoist capable of lifting both carts 16 and cargo containers 1.

In the embodiment shown in FIG. 14, carts 16 may be moved from a delivery lane 24, used to deliver cart 16 loaded with containers 1, to a return lane 26, used to return carts 16 after the container 1 has been unloaded. Carts 16 may also be moved from a return lane 26 to a delivery lane 24 according to need. Thus, first trolley hoist 92 could be used to retrieve container 1 from cart 16 and once it is cleared from the area, second trolley hoist 94 may be used to transfer cart 16 from delivery lane 24 to return lane 26. A yard gantry crane 22 with dual trolleys 92, 94 can perform these actions faster than a single trolley crane. It should be understood that either trolley hoist 92, 94 may be capable of lifting more than one cart 16 simultaneously due to the fact that carts 16 are smaller and lighter and containers 1.

Another embodiment for shifting carts from one lane to another involves portal cranes 120A and 120B such as those shown in FIGS. 15A and 15B. A portal crane 120 is a gantry crane which does not have cantilevered sections such as the cantilevered sections 42 shown as parts of gantry cranes 22 in FIG. 4. Each portal crane 120 provides dedicated to a container stacking area 122, as shown in FIG. 15A, showing two adjoining container stacking areas 122A and 122B wherein each container stacking area is served by one portal crane 120A, 120B and wherein a cart lane 124 is provided underneath and between the legs 126 of portal crane 120A such that containers being carried on carts moving in lane 124 can be accessed by a trolley hoist mechanism suspended from its top beams 128, and cart lane 130 is provided underneath and between the legs 126 of portal crane 122B such that containers being carried on carts moving in lane 130 can be accessed by a trolley hoist mechanism suspended from its top beams 128. One disadvantage of portal cranes is that adjacent portal cranes, each serving a separate container stacking area cannot share the same container cart tracks. In FIG. 15A, for example, portal crane 120A does not have access to container cart lane 130. However, a cart shifting device 132 can be suspended from the portal beam 134 extending between two of the legs 126 on one side of a portal crane 120. See FIG. 15B. In their stowed positions, the legs 138 of the cart shifting device 132 are disposed under the portal beam 136 as shown in FIG. 15B. An improved configuration for container stacking areas being served by portal cranes 120 is shown in FIG. 15A in which cart lane 140 is disposed between portal cranes 120. Lanes 124, 130 and 140 and the legs of portal cranes 120 are positioned so that the cart shifting mechanisms 132 suspended from the portal beams 136 of the portal cranes 120 are able to deploy their arms 138 to extend under a cart in one of the lanes 124, 130 and 140, pick it up, rotate, and place the cart in an adjacent lane. For example, if a container cart were in lane 124 adjacent the cart shifting device 132 suspended from one of the portal cranes 120, the cart shifting device 132 could extend its arms 138 underneath container cart, elevate it from the tracks in lane 124, rotate such that the cart is swiveled over lane 140, and set down onto the tracks in lane 140. A cart shifting mechanism suspended from the portal crane 120 could, in like fashion, then move the container cart from lane 140 to lane 130.

### Example

### Operations and Layout with Multiple Cart Lanes

This section describes a container storage yard layout and operation with multiple cart lanes according to the invention.

FIG. 16 shows a simplified overhead representation of a layout such as that seen in FIG. 2, in which there are two container stacking areas 12A and 12B, each stacking area 12A, 12B having a dedicated delivery lane 24A, 24B, and a yard gantry crane 22. The dedicated delivery lanes 24A, 24B allow linear transportation of loads in the direction of the lane. A return lane 26 for empty carts is disposed between the delivery lanes 24A, 24B and is intended to circulate empty carts back in the opposite direction for reuse. Each yard gantry crane 22 has a cantilevered section 96 extending over and providing access to one of the delivery lanes 24A or 24B and return lane 26 such that empty carts 16 can be transferred from delivery lanes 24A, 24B to return lane 26. Cart shifting devices 18 are used to shift carts 16 between delivery lanes 24A, 24B and return lane 26 at remote ends of the yard layout. Ground transportation vehicles 4 deliver containers to gate handling equipment 20 areas where the containers are removed from the ground transportation vehicles 4 and transferred to carts 16 on delivery lanes 24A, 24B.

Given the layout shown in FIG. 16, one method for transferring carts 16 from ground transportation vehicles to container stacking areas 12 is shown in FIG. 16. A container is transferred from ground transportation 4, which is parked underneath gate handling equipment 20, to delivery lane 24 as indicated by arrow A. Then it is moved along delivery lane 24 to yard gantry crane 22 as indicated by arrow B. Finally, the container is unloaded from the cart in delivery lane 24 and deposited in container stacking area 12 as indicated by arrow C.

Carts circulate by being moved initially from return lane 26 to delivery lane 24 by cart shifting device 18 in a forward transfer area, as indicated by arrow D, whence it moves under gate handling equipment 20 to receive a container. The cart then moves with its container load along delivery lane 24 to yard gantry crane 22, where it is unloaded, to a remote transfer area, as indicated by arrow E. The cart is then transferred from delivery lane 24 to return lane 26 as indicated by arrow F. Finally, the cart is returned to the forward transfer area as indicated by arrow G.

The operation pattern shown in FIG. 17 allows the use of container trains such as those shown in FIG. 1E. The gate handling equipment 20 constructs the container trains by depositing a container on two carts, and then moving the carts forward to provide the appropriate amount of space between the next two carts for the next container on the train. Once a sufficiently long train is formed, it proceeds to the yard gantry crane 22, which pulls containers off one by one, or in sets, and frees the carts to circulate back to the beginning.

During discharge operations, where containers are transferred from the container stacking area 12 to external vehicles 4, the operation proceeds in reverse of the steps described above. The designated direction of movement in each lane can be reversed as needed depending on where containers are to be delivered or received. In a discharging operation, the yard gantry crane 22 can also form container trains 98 as shown in FIG. 18.

Referring now to FIG. 19, a yard gantry crane 22 can also transfer carts between lanes 24, 26. A container is transferred from ground transportation 4, which is parked underneath gate handling equipment 20, to delivery lane 24 as indicated by arrow A. Then it is moved along delivery lane 24 to yard gantry crane 22 as indicated by arrow B. Finally, the container is unloaded from the cart in delivery lane 24 and deposited in container stacking area 12 as indicated by arrow C.

The cart is circulated by being moved initially from return lane 26 to delivery lane 24 by cart shifting device 18 in a forward transfer area, as indicated by arrow D, whence it moves under gate handling equipment 20 where it and another cart receive a container. The cart then moves with its container load along delivery lane 24 to yard gantry crane 22, along the path indicated by arrow B, where it is unloaded. The cart is then transferred from delivery lane 24 to return lane 26 by yard gantry crane 22, perhaps using the auxiliary trolley hoist 94 (see FIG. 14), as indicated by arrow E. Finally, the cart is returned to the forward transfer area along return lane 26, as indicated by arrow F. This operation differs from that shown in FIG. 16 in that the total distance of the cycle path for the carts is reduced. By utilizing the yard gantry crane 22 to transfer the cart from the delivery lane 24 to the return lane 26, the carts travel substantially shorter distances and need not travel the full length of one of the lanes 24, 26 to a cart shifting device 18.

Another embodiment of a container yard layout, similar to that shown in FIG. 19, is depicted in FIG. 20. A single container stacking area 150 is served by two gantry cranes 152F and 152R. Similarly to the traffic pattern shown in FIG. 18, a container cart is moved from return lane 26 to delivery lane 24, along the path indicated by arrow A, by cart shifting device 18F in a forward cart transfer area 154F. It then moves under gate handling equipment 20F where it and another cart receive a container. The carts then move with their container load along delivery lane 24 to forward yard gantry crane 152F along the path indicated by arrow B where the container is unloaded. The carts are then transferred from delivery lane 24 to return lane 26 by a hoist on yard gantry crane 152F, as indicated by arrow C. Finally, the carts are returned to the forward cart transfer area 154F in return lane 26 along the path indicated by arrow D. The carts in this forward traffic pattern thus move in a clockwise pattern.

A similar, but reversed traffic pattern can be actively employed at the other end of the container stacking yard. Thus, a container cart is moved from return lane 26 to delivery lane 24, along the path indicated by arrow E, by cart shifting device 18R in a rear cart transfer area 154R. It then moves under gate handling equipment 20 where it and another cart received a container. The carts then move with the container load along delivery lane 24 to rear yard gantry crane 152R along the path indicated by arrow F where the container is unloaded. The carts are then transferred from delivery lane 24 to return lane 26 by a hoist on yard gantry crane 152R, as indicated by arrow G. Finally, the carts are returned to the rear cart transfer area 154R in return lane 26 along the path indicated by arrow H. The carts in this rear traffic pattern thus move in a counter-clockwise pattern. In such a configuration as shown in FIG. 20, container handling carts running in two lanes adjacent a container stacking area can maximize efficient transport of containers along the container stacking area and improve usage of the gantry cranes for stacking and maintaining containers in the container stacking area.

### CONCLUSION

A container storage yard transportation system according to the invention uses container carts as rapid cargo container transport conduits within the storage yard. FIG. 21 shows that the area served by trucks and chassis, and alternative container transportation vehicles, encompasses the entire container storage yard. Handling carts according to the invention replace terminal tractors entirely for cargo container handling within the confines of the cargo storage yard. Thus, as shown in FIG. 22, the area served by trucks and chassis and other container transportation vehicles is dramatically reduced by implementation of the invention. The layouts and methods of use described above will provide improvements in efficiency, flexibility, and productivity for container ports that implement a container storage yard transportation system using container handling carts.

There have thus been described and illustrated certain embodiments of a container storage yard transportation system. While certain embodiments have been described and disclosed, it will be recognized by those with skill in the art that modifications are within the true spirit and scope of the invention. The appended claims and their legal equivalents are intended to cover all such modifications.

We claim:

1. A container storage yard transportation system comprising:
at least one container stacking area,
at least one cart lane adjacent said at least one container stacking area,
a plurality of container handling carts movably disposed in said at least one cart lane, each said cart capable of supporting one end of a container, said carts for transporting containers to selected points along said at least one cart lane,
gate handling equipment for transferring containers between ground transportation vehicles and said carts, and
at least one yard crane for moving containers between said carts at said selected points and said at least one container stacking area.

2. The container storage yard transportation system of claim 1 wherein:
each said container handling cart has two end portions and a container guide intermediate each said end portion, each end portion capable of supporting the end of a container such that each cart is capable of supporting the ends of two adjacent containers spaced apart by said container guide.

3. The container storage yard transportation system of claim 1 wherein:
said gate handling equipment is comprised of two or more fixed columns,
a bridge extending between said columns, and
one or more hoist trolleys mounted on said bridge and movable between positions over said at least one cart lane and ground transportation vehicles parked under said bridge.

4. The container storage yard transportation system of claim 1 wherein:
said at least one cart lane including at least two cart lanes, and
a cart shifting mechanism for shifting carts between said at least two cart lanes.

5. The container storage yard transportation system of claim 4 wherein:
said at least one cart lane includes a delivery lane in which said carts move in a first direction and a return lane in which said carts move in a second direction opposite said first direction, said delivery lane having a loading position where containers may be loaded onto said carts by said gate handing equipment, and an unloading position where containers may be removed from said carts by said at least one yard crane, and said return lane for returning empty carts to said loading position.

6. The container storage yard transportation system of claim 4 wherein:
each said lane is comprised of rails,
each said cart has wheels which run on said rails, and
said cart shifting mechanism is comprised of said lanes each having a conveyor and a jack for lifting said conveyor from a rest position to an elevated position, and each said cart having a frame and a jacking pad depending from said frame, such that in said rest position said conveyor is vertically spaced from said jacking pad, and in said elevated position said wheels of said cart are elevated above said rails so that said cart may be translated on said conveyors from one of said lanes to the other.

7. The container storage yard transportation system of claim 6 further comprising:
a bridge conveyor between said lanes for translating said carts between said lanes.

8. The container storage yard transportation system of claim 4 wherein:
said cart shifting mechanism is comprised of a stationary rotatable forklift disposed between said lanes, said forklift having forks extendable between a retracted position and an extended position, said forklift movable between a lowered position and an elevated position, and said forklift rotatable from a first position in which said forks in said extended position are positioned over one of said lanes to a second position in which said forks in said extended position are positioned over the other of said lanes,
such that said forks can be extended to said extended position for positioning underneath a cart in one of said lanes, raising said forklift from said lowered position to said elevated position lifts said cart free of said lane, rotation of said forklift from said first position to said second position translates said cart from said one lane to the other of said lanes, and lowering said forklift deposits said cart in said other lane.

9. The container storage yard transportation system of claim 4 wherein:
said cart shifting mechanism is comprised of a piston disposed between said lanes, a lifting arm extending from said piston, and said arm rotatable from a first position over one of said lanes to a second position over the other of said lanes, said piston movable between an elevated position and a lowered position, said arm having an attachment mechanism for attaching said arm to a cart in one of said lanes,
such that when said piston is in said elevated position said arm may be rotated over a cart in one of said lanes, moving said piston from said elevated position to said lowered position places said attachment mechanism over said cart, raising said piston from said lowered position to said elevated position lifts a cart attached to said attachment mechanism free of said lane, rotation of said arm from said first position to said second position translates said cart from said one lane to the other of said lanes, and lowering of said piston from elevated position to said lowered position deposits said cart in said other lane.

10. The container storage yard transportation system of claim 9 wherein:
said attachment mechanism is comprised of one or more twistlocks depending from said arm, and said carts having one or more cavities and a top surface having one or more openings each in communication with one of said cavities, said one or more top openings each having a rectangular configuration suitable for receiving a twistlock, each said cavity sized to permit rotation of one of said twistlocks in said cavity.

11. The container storage yard transportation system of claim 1 wherein:
said at least one cart lane is comprised of at least two cart lanes, and
said at least one yard crane has first and second hoist trolleys, said first hoist trolley being disposed over said cart lanes and capable of transferring carts between said at least two cart lanes, and said second hoist trolley being disposed over at least one of said at least two cart lanes and said at least one container stacking area for transferring containers between carts in said at least one of said two cart lanes and said at least one container stacking area.

12. The container storage yard transportation system of claim 11 wherein:
said at least one yard crane has a cantilevered section extending over at least one of said at least two cart lanes.

13. The container storage yard transportation system of claim 12 wherein:
said at least one yard crane is comprised of a gantry crane having a pair of legs disposed between said at least two cart lanes and said at least one container stacking area.

14. The container storage yard transportation system of claim 12 wherein:
said at least one yard crane is comprised of a gantry crane having a pair of legs disposed between two of said at least two cart lanes.

15. The container storage yard transportation system of claim 1 wherein:
said at least one container stacking area is comprised of two container stacking areas,
said at least one cart lane is comprised of two delivery lanes and a return lane between said two delivery lanes, said delivery and return lanes disposed between said two container stacking areas, and
said at least one yard crane includes at least two yard cranes, each of said at least two yard cranes for moving containers between said container handling carts and one of said container stacking areas, each said yard crane having a cantilevered section extending over said return lane and at least one hoist trolley for transferring carts between said return lane and one of said delivery lanes.

16. The container storage yard transportation system of claim 13 wherein:
said at least two yard cranes are comprised of a first gantry crane movable along one of said two container stacking areas and a second gantry crane movable along the other of said two container stacking areas, and said cantilevered section of said first gantry crane is vertically spaced from said cantilevered section of said second gantry crane.

17. The container storage yard transportation system of claim 14 wherein:
said first gantry crane has a pair of legs disposed between said two container stacking areas, and said cantilevered section of said second gantry crane is horizontally spaced from said legs.

18. The container storage yard transportation system of claim 1 wherein:
said at least one cart lane is comprised of at least two cart lanes, and
said at least one yard crane has a cantilevered section extending over said at least two cart lanes.

19. The container storage yard transportation system of claim 18 wherein:
said at least one cart lane is comprised of a gantry crane having a pair of legs disposed between said at least one container stacking area and said at least two cart lanes.

20. The container storage yard transportation system of claim 18 wherein:
said at least one cart lane is comprised of a gantry crane having a pair of legs disposed between two of said at least two cart lanes.

21. A container storage yard transportation system comprising:
at least one container stacking area,
at least two cart lanes adjacent said at least one container stacking area,
a plurality of container handling carts, each said cart having two end portions and a container guide intermediate each said end portion, each end portion capable of supporting the end of a container such that each cart is capable of supporting the ends of two adjacent containers abutting and spaced apart by said container guide, said carts movably disposed in said at least one cart lane for transporting containers to selected points along said at least one cart lane,
gate handling equipment for transferring containers between ground transportation vehicles and said carts, and
at least one yard crane for moving containers having first and second hoist trolleys, said first hoist trolley being disposed over said cart lanes and capable of transferring carts between said at least two cart lanes, and said second hoist trolley being disposed over at least one of said at least two cart lanes and said at least one container stacking area for transferring containers between carts at said selected points and said at least one container stacking area.

22. A container storage yard transportation system comprising:
two container stacking areas,
a plurality of cart lanes intermediate said two container stacking areas, said plurality of cart lanes including two delivery lanes and a return lane between said two delivery lanes,
a plurality of container handling carts, each said cart having two end portions and a container guide intermediate each said end portion, each end portion capable of supporting the end of a container such that each cart is capable of supporting the ends of two adjacent containers abutting and spaced apart by said container guide, said carts movably disposed in said cart lanes for transporting containers to selected points along said delivery lanes,
gate handling equipment for transferring containers between ground transportation vehicles and said carts, said gate handling equipment having two or more fixed columns, a bridge extending between said columns, and one or more hoist trolleys mounted on said bridge and movable between positions over said cart lanes and ground transportation vehicles parked under said bridge, and
first and second gantry cranes, said first gantry crane movable along one of said container stacking areas for moving containers between said container handling carts and said one container stacking area, and said second gantry crane movable along the other of said container stacking areas for moving containers between said container handling carts and said other container stacking area, each said gantry crane having first and second hoist trolleys and a cantilevered section extending over said return lane,
said first hoist trolley being disposed over said return lane and one of said delivery lanes and capable of transferring carts between said return lane and said delivery lane,
said second hoist trolley being disposed over one of said delivery lanes and one of said two container stacking areas for transferring containers between carts at said selected points and said container stacking area, and
said first gantry crane having a pair of legs disposed between said two container stacking areas, said cantilevered section of said second gantry crane horizontally spaced from said legs and vertically spaced from said cantilevered section of said first gantry crane such that said first gantry crane may freely pass said second gantry crane as said gantry cranes move along said container stacking areas.

23. A method for transporting containers within a container storage yard, the method comprising:
transferring a container from ground transportation to two container handling carts at a loading position in a container cart delivery lane, each said cart supporting one end of said container,
moving said container on said carts to an unloading position in said delivery lane alongside a container stacking area,
transferring said container from said carts to said container stacking area,
shifting said carts from said delivery lane to a return lane,
moving said carts in said return lane to a cart shifting area,
shifting said carts from said return lane to said delivery lane in said cart shifting area, and
moving said carts to said loading position.

24. The method of claim 23 wherein:
each of said carts has two end portions and a container guide intermediate each said end portion, each end portion capable of supporting the end of a container such that each cart is capable of supporting the ends of two adjacent containers spaced apart by said container guide.

25. The method of claim 23 further comprising:
said shifting of said carts from said return lane to said delivery lane being performed at a first cart shifting area,
moving said carts in said delivery lane to a second cart shifting area, and
said shifting said carts from said delivery lane to said return lane is performed at said second cart shifting area.

26. The method of claim 25 further comprising:
said shifting said carts from said delivery lane and said shifting said carts from said return lane to said delivery are performed using cart shifting mechanisms.

27. A method for transporting containers within a container storage yard, the method comprising:
transferring a container from ground transportation to two container handling carts at a loading position in a container cart delivery lane, each said cart supporting one end of said container,
moving said container on said carts to an unloading position in said delivery lane along a container stacking area,
transferring said container from said carts to said container stacking area with a gantry crane,
shifting said carts from said delivery lane to a return lane using said gantry crane,
moving said carts in said return lane to a cart shifting area,
shifting said carts from said return lane to said delivery lane, and
moving said carts to said loading position.
